(19) United States
(12) Patent Application Publication
(10) Pub. No.: US 2017/0321533 A1
(43) Pub. Date: Nov. 9, 2017

(54) IDENTIFYING A COMPONENT USED IN A WELL OPERATION USING A LEAKY COAXIAL ANTENNA

(71) Applicant: Blake C. Burnette, Tomball, TX (US)

(72) Inventor: Blake C. Burnette, Tomball, TX (US)

(73) Assignee: Baker Hughes Incorporated, Houston, TX (US)

(21) Appl. No.: 15/149,957

(22) Filed: May 9, 2016

(51) Int. Cl. E21B 47/00; G01F 1/74

(52) U.S. Cl. CPC E21B 47/00; G01F 1/74

(57) ABSTRACT

Examples of identifying a component used in a well operation using a leaky coaxial antenna are disclosed. In aspects of the present disclosure, a method may include: reading an electronic identifier connected to a component used in the well operation via the leaky coaxial antenna to obtain a unique identifier, wherein the electronic identifier comprises the unique identifier; identifying the component from a plurality of components by comparing the unique identifier to a plurality of unique identifiers stored in a data store; receiving usage data from a sensor connected to the identified component; storing, by the processing system, the usage data in the data store for the identified component; and determining a failure risk level for the component based at least in part on the stored usage data for the identified component, wherein the leaky coaxial antenna comprises a plurality of radiating regions and a plurality of non-radiating regions.

### BACKGROUND

The present disclosure relates to well operations and, more particularly, to identifying a component used in a well operation using a leaky coaxial antenna.

Boreholes are drilled into earth formations having reservoirs of hydrocarbons in order to extract the hydrocarbons through the boreholes to the surface. Various components (e.g., pipe segments, pipe couplings, pipe valves, manifolds, etc.) connect equipment trucks (e.g., blending trucks, pumping trucks, etc.) at the earth's surface to the bore holes. The components that connect the equipment trucks to the boreholes carry fluid, such as drilling fluid, to the boreholes to be used to extract the hydrocarbons through the boreholes. The drilling fluid may be a mixture of solids (e.g., sand) and liquids (e.g., water). Over time, the drilling fluid may cause damage to or otherwise degrade the components, thereby shortening the useful life of a component and/or leading to catastrophic failure of a component.

### BRIEF SUMMARY

According to aspects of the present disclosure, techniques including methods, systems, and/or computer program products for identifying a component used in a well operation using a leaky coaxial antenna are provided. An example method may include: reading, by a processing system, an electronic identifier connected to a component used in the well operation via the leaky coaxial antenna to obtain a unique identifier, wherein the electronic identifier comprises the unique identifier; identifying, by the processing system, the component from a plurality of components by comparing the unique identifier to a plurality of unique identifiers stored in a data store; receiving, by the processing system, usage data from a sensor connected to the identified component; storing, by the processing system, the usage data in the data store for the identified component; and determining, by the processing system, a failure risk level for the component based at least in part on the stored usage data for the identified component, wherein the leaky coaxial antenna comprises a plurality of radiating regions and a plurality of non-radiating regions.

According to additional aspects of the present disclosure, an example system may include: a memory having computer readable instructions; and a processing device for executing the computer readable instructions. The computer readable instructions may include: reading, by a processing system, an electronic identifier connected to a component used in the well operation via the leaky coaxial antenna to obtain a unique identifier, wherein the electronic identifier comprises the unique identifier; identifying, by the processing system, the component from a plurality of components by comparing the unique identifier to a plurality of unique identifiers stored in a data store; measuring, by a density sensor in fluid communication with the component used in the well operation, a volume of sand flowing through the component over a period of time; measuring, by a flow sensor in fluid communication with the component used in the well operation, a volume of fluid flowing through the component over the period of time; storing, by the processing system, the volume of sand and volume of water flowing through the component over the period of time as usage data in the data store for the identified component; and determining, by the processing system, a failure risk level for the component based at least in part on the stored usage data for the identified component, wherein the leaky coaxial antenna comprises a plurality of radiating regions and a plurality of non-radiating regions.

Additional features and advantages are realized through the techniques of the present disclosure. Other aspects are described in detail herein and are considered a part of the disclosure. For a better understanding of the present disclosure with the advantages and the features, refer to the following description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings in which:

FIG. 1 illustrates a block diagram of a plurality of components connected to pump trucks used in a well operation and a component identification system to identify the components used in the well operation using a leaky coaxial antenna according to aspects of the present disclosure;

FIG. 2 illustrates a block diagram of a plurality of components stored on a vehicle used in a well operation and a component identification system to identify the components used in the well operation using a leaky coaxial antenna according to aspects of the present disclosure;

FIG. 3 illustrates a well operation having a drilling/production rig for drilling a borehole and/or producing hydrocarbons according to aspects of the present disclosure;

FIG. 4 illustrates a block diagram of a processing system to identify and determine wear of a component used in a well operating according to examples of the present disclosure;

FIG. 5 illustrates a flow diagram of a method for identifying a component used in a well operation using a leaky coaxial antenna according to examples of the present disclosure; and

FIG. 6 illustrates a block diagram of a processing system for implementing the techniques described herein according to examples of the present disclosure.

### DETAILED DESCRIPTION

The present techniques reduce the likelihood of a catastrophic failure of a component by identifying a component and determining a failure risk level for the component based on usage data for the component. A user can be alerted when a component reaches a threshold level of usage that may cause the component to degrade. This enables the components to be removed from use and/or serviced to prevent a failure. These and other advantages will be apparent from the description that follows.

Various implementations are described below by referring to several examples of identifying a component used in a well operation using a leaky coaxial antenna. The components described herein may be pipe segments, pipe couplings, pipe valves, manifolds, and the like, and may be constructed partially, substantially, or wholly from iron. However, in other examples, the components described herein may be comprised of materials other than or in addition to iron.

The teachings of the present disclosure can be applied in a variety of well operations. These operations may involve using one or more treatment agents to treat a formation, the fluids resident in a formation, a wellbore, and/or equipment in the wellbore, such as production tubing. The treatment agents may be in the form of liquids, gasses, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water-flooding, cementing, etc.

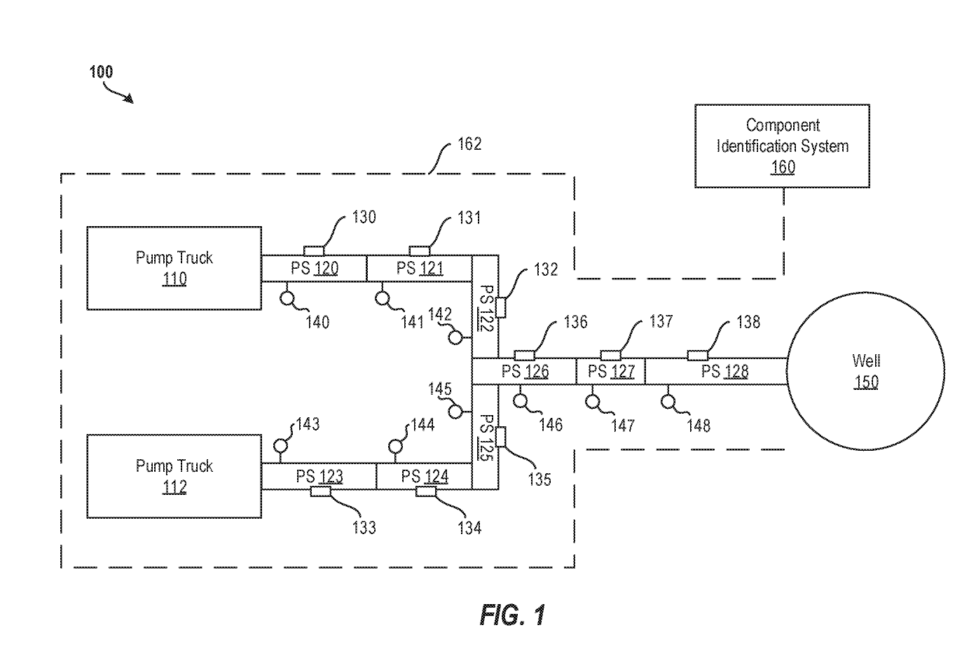

FIG. 1 illustrates a block diagram of a plurality of components (e.g., pipe segments (PS) 120, 121, 122, 123, 124, 125, 126, 127, 128) connected to pump trucks 110, 112 used in a well operation 100 and a component identification system 160 to identify the components used in the well operation using a leaky coaxial antenna 162 according to aspects of the present disclosure. The plurality of pipe segments 120-128 each includes an electronic identifier 130, 131, 132, 133, 134, 135, 136, 137, 138 connected to the pipe segments 120-128 respectively.

It should be appreciated that, although pipe segments are illustrated in and discussed with respect to FIG. 1 (and with respect to other figures herein), other components as discussed herein may be implemented instead of, in addition to, and/or in combination with the pipe segments 120-128. Additionally, the pump trucks 110, 112 may be other types of trucks or equipment suitable for use at the well operation 100, and the description of pump trucks should not be interpreted as limiting.

In aspects of the present disclosure, the electronic identifiers 130-138 may be, radio frequency identification (RFID) tags (i.e., an active RFID tag or a passive RFID tag), microcontrollers comprising a wireless input/output (I/O) connection, and/or other devices for automatic identification and data capture. In each case, the electronic identifiers 130-138 identify the pipe segments 120-128 using a unique identifier that is unique to each of the pipe segments 120-128.

The component identification system 160 utilizes a leaky coaxial antenna 162 to send and receive signals to and from the electronic identifiers 130-138. The leaky coaxial antenna 162 comprises radiating regions and non-radiating regions. For example, the coaxial cable may contain regions in which shielding is removed to enable signals to be transmitted or “leaked” into or out of the coaxial cable along the length of the coaxial cable. The dashed lines in FIG. 1 used to illustrate the leaky coaxial antenna 162 may represent the radiating regions as dashes and the non-radiating regions as blank/white space between the dashes.

In an example in which the electronic identifiers 130-138 are active or passive RFID tags, the unique identifiers may be a unique electronic code stored in each RFID tag that uniquely identifies each pipe segment 120-128 respectively. In this case, the leaky coaxial antenna 162 reads the RFID tags (i.e., the electronic identifiers 130-138) and receives the unique identifier for each of the electronic identifiers 130-138.

The leaky coaxial antenna 162 may be installed at the well operation 100 in proximity to the components 120-128 such that the component identification system 160 can read the electronic identifiers 130-138 via a signal transmitted from the leaky coaxial cable. In the case of passive RFID tags, the leaky coaxial antenna 162 may be placed in closer proximity to the components 120-128 as compared to examples using passive RFID tags. In the case of passive RFID tags, additional leaky coaxial antenna may be used to achieve coverage of the desired area of the well operation 100.

In an example using a microcontroller as electronic identifiers 230-235, the microcontroller may also store a unique electronic code that uniquely identifies each pipe segment 120-128 respectively, which may be output via the wireless I/O connection in communication with the component identification system 160 via the leaky coaxial antenna 162.

According to aspects of the present disclosure, the pipe segments 120-128 include a sensor including, for example, a density sensor and/or a flow sensor, which may be individual sensors or which may be combined as a sensor array. Sensors 140, 141, 142, 143, 144, 145, 146, 147, 148 are illustrated in FIG. 1 as corresponding respectively to pipe segments 120-128. The sensors 140-148 may measure a volume of solid (e.g., sand) and/or a volume of fluid (e.g., water) passing through the respective pipe segments 120-128 over a period of time. Although not illustrated in FIG. 1, the sensors 140-148 are configured to transmit the measurements via the leaky coaxial antenna 162 to the component identification system 160.

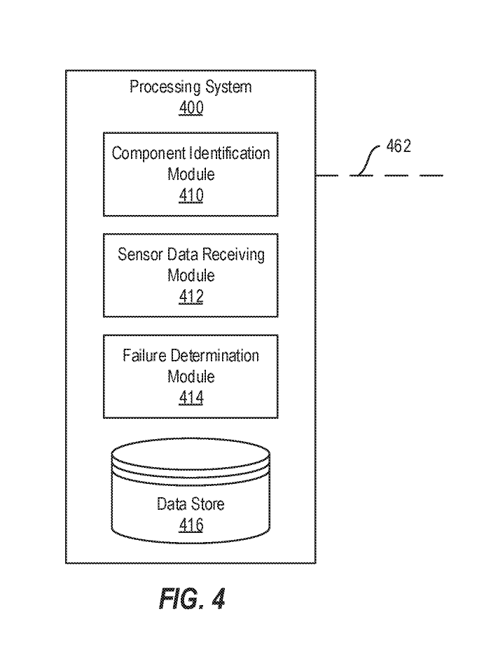

The component identification system 160 identifies components and determines a failure risk level (e.g., determines the amount of wear) for the components. An example of an identification and wear determination system 160 is illustrated as processing system 400 of FIG. 4 and is discussed below.

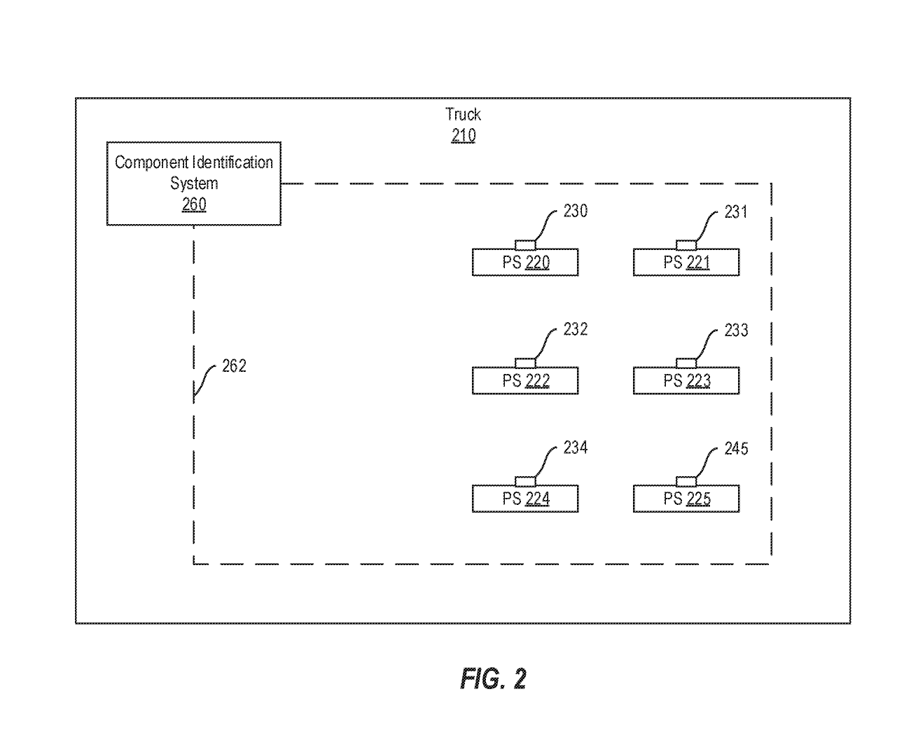

FIG. 2 illustrates a block diagram of a plurality of components (e.g., pipe segments (PS) 220, 221, 222, 223, 224, 225) stored on a vehicle 210 used in a well operation (e.g., well operation 100 of FIG. 1) and a component identification system 260 to identify the components used in the well operation using a leaky coaxial antenna 262 according to aspects of the present disclosure. The plurality of pipe segments 220-225 each includes an electronic identifier 230, 231, 232, 233, 234, 235 connected to the pipe segments 220-225 respectively. It should be appreciated that, although FIG. 2 illustrates a vehicle 210, any suitable storage facility may be utilized in other examples (e.g., a shipping container, a warehouse, a trailer, etc.).

In aspects of the present disclosure, the electronic identifiers 230-235 may be, radio frequency identification (RFID) tags (i.e., an active RFID tag or a passive RFID tag), microcontrollers comprising a wireless input/output (I/O) connection, and/or other devices for automatic identification and data capture. In each case, the electronic identifiers 230-235 identify the pipe segments 220-225 using a unique identifier that is unique to each of the pipe segments 220-225.

The leaky coaxial antenna 262 may be installed on or in the vehicle 210. The components 220-225 may be stored in or on the vehicle 210 in proximity to the leaky coaxial antenna 262 such that the component identification system 260 can read the electronic identifiers 230-235 via a signal transmitted from the leaky coaxial cable. In the case of passive RFID tags being implemented as electronic identifiers 230-235, the leaky coaxial antenna 262 may be placed in closer proximity to the components 220-225 as compared to examples using passive RFID tags. In the case of passive RFID tags, additional leaky coaxial antenna may be used to achieve coverage of the desired area of the vehicle 200.

In an example using a microcontroller being implemented as electronic identifiers 230-235, the microcontroller may also store a unique electronic code that uniquely identifies each pipe segment 220-225 respectively, which may be output via the wireless I/O connection in communication with the component identification system 260 via the leaky coaxial antenna 262.

The component identification system 260 identifies components and determines a failure risk level (e.g., determines the amount of wear) for the components. An example of an identification and wear determination system 260 is illustrated as processing system 400 of FIG. 4 and is discussed below.

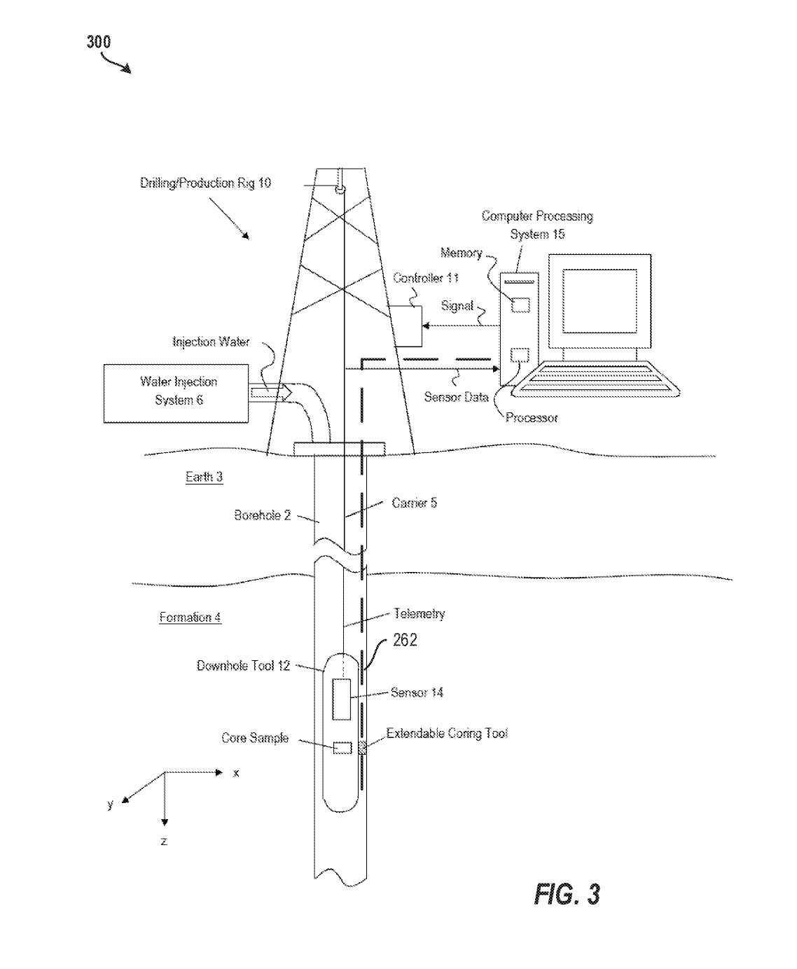

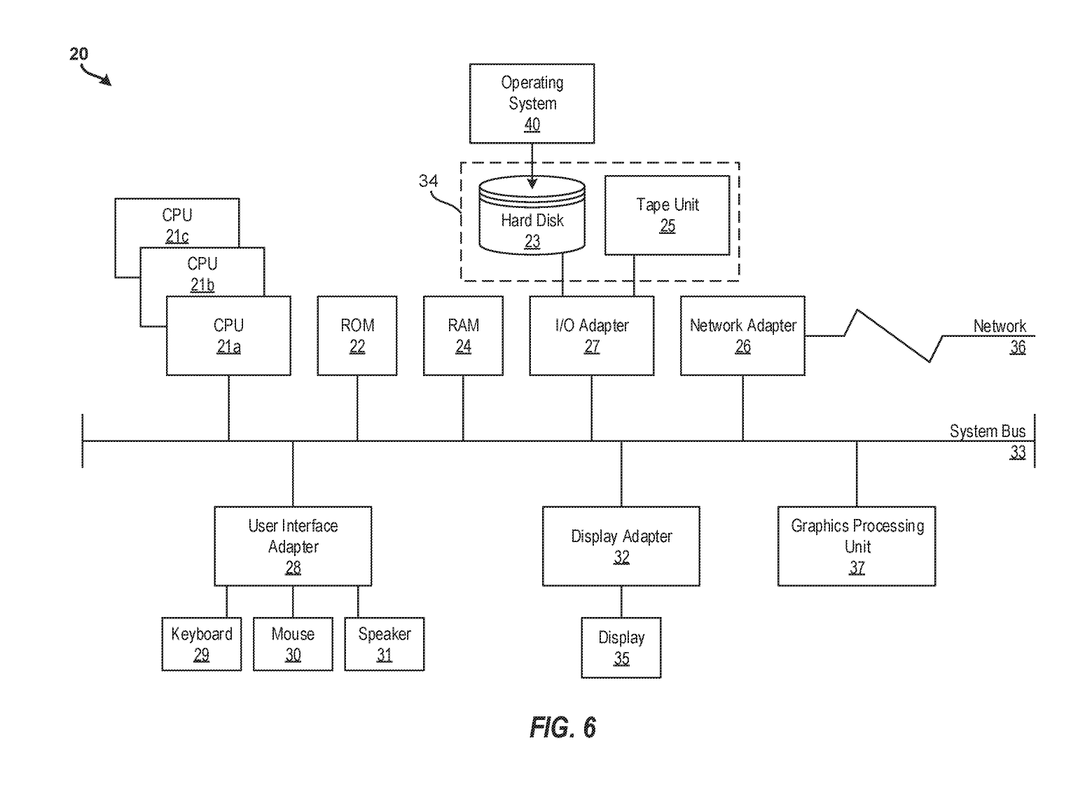

FIG. 3 illustrates is a cross-sectional view of a borehole 2 (may also be referred to as a well) penetrating the earth 3 having a formation 4, which contains a reservoir of hydrocarbons. The borehole 2 may be vertical as illustrated in FIG. 6 or deviated or horizontal. A drilling/production rig 10 is configured to drill the borehole 2 and/or perform completion and production actions relating to extracting hydrocarbons from the formation 4. The drilling/production rig 10 includes a controller 11 configured to control various operations performed by the drilling/production rig 10 such as controlling a pumping rate and corresponding duration for water injection purposes. The controller 11 is further configured to receive a signal, such as from a computer processing system 15, providing the controller 11 with instructions, such as a set point or operating curve for example, for controlling the various operations. The computer processing system 15 may also be a component identification system (e.g., component identification system 160 or component identification system 260) configured to implement the actions of the method 400 to include identifying the components used in the well operation using a leaky coaxial antenna 362. As illustrated in FIG. 3, the leaky coaxial antenna 362 may be installed in the borehole 2 at the well operation 300 in proximity to a component (e.g., downhole tool 8) such that an electronic identifier on the downhole tool 8 is readable by the computer processing system 15 via the leaky coaxial cable 362.

A casing 5 such as a drill tubular or drill string for drilling the borehole 2 or an armored wireline for wireline logging embodiments may be disposed in the borehole 2 along with the leaky coaxial cable 362. A downhole tool 12 is conveyed through the borehole by the carrier 5. The downhole tool 12 includes a sensor 14 for sensing a property of the borehole 2 or formation 4. Although not shown, the downhole tool 8 may also include an electronic identifier (e.g., a RFID tag, a microcontroller, etc.) as described herein.

In addition, the downhole tool 12 may be configured to extract a core sample from the formation 4 using an extendable coring tool. The core sample may be analyzed downhole using the sensor 14 to determine one or more properties or parameters of the core sample and thus the formation 4 or it may be analyzed in a laboratory at the surface using micro-photography or X-ray techniques for example. The information determined from the core sample and/or formation logging measurements may be used to determine the DFN of the formation 4. Sensed downhole properties or parameters may be transmitted to the computer processing system 15 using telemetry, which can be the armored wireline, pulsed-mud, or wired drill pipe as non-limiting embodiments.

The drilling production rig 10 may also include a water injection system 6 controllable by the controller 11 for injecting water into the formation 4.

In support of the teachings herein, various analysis components may be used, including a digital and/or an analog system. For example, the drilling/production rig 10, controller 11, the downhole tool 12, the sensor 14, and/or the computer processing system 15 may include digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

In particular, FIG. 4 illustrates a block diagram of a processing system 400 to identify and determine wear of a component used in a well operating according to examples of the present disclosure. The processing system 400 is one example of the component identification system 160 illustrated in FIG. 1, the component identification system 260 illustrated in FIG. 2, and/or the computer processing system 15 illustrated in FIG. 3. The functionality of the processing system 400 is discussed below with reference to the elements illustrated in FIG. 1.

The various components, modules, engines, etc. described regarding FIG. 4 may be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the engine(s) described herein may be a combination of hardware and programming. The programming may be processor executable instructions stored on a tangible memory, and the hardware may include a processing device for executing those instructions. Thus, a system memory can store program instructions that when executed by a processing device implement the modules described herein. Other modules may also be utilized to include other features and functionality described in other examples herein.

In aspects of the present disclosure, processing system 400 includes a component identification module 410, a sensor data receiving module 412, a failure determining module 414, and a data store 416. Alternatively or additionally, the processing system 400 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein.

The component identification module 410 identifies a component from a plurality of components using an identifier connected to the component. The identifier includes a unique identifier to identify the component from the plurality of components. For example, a RFID tag or another identifier on a component (or multiple components) is read via a leaky coaxial antenna 462 connected to the processing system. The component identification module 410 identifies the component based on data stored in the data store 416. For example, the unique identifier of the component is stored in the data store 416 along with any relevant data relating to the component, such as a time stamp when the component is installed, serviced, removed, etc.

The sensor data receiving module 412 receives data relating to solid and/or fluid passing through the component. For example, a sensor (e.g., a density sensor) measures a volume of sand passing through the component over a period of time. Similarly, a sensor (e.g., a flow sensor) measures a volume of fluid passing through the component over the period of time. The sensor data receiving module 412 receives the sensor data from the respective sensors (or sensor array). Additionally, in examples, the sensor data receiving module 412 stores the received sensor data to the data store 416 as usage data. The usage data stored in the data store 416 is associated with the identified component to track the usage of the identified component.

The failure determination module 414 determines a failure risk level for the component using the received sensor data and/or the usage data stored in the data store 216. In some examples, the failure determination module 414 determines a failure risk level for the component based at least in part on the usage data for the identified component. In additional aspects of the present disclosure, the failure determination module 414 determines a failure risk level for the component based at least in part on the volume of sand passing through the component over the period of time and based at least in part on the volume of fluid passing through the component over the period of time.

The data store 416 stores the period of time that the component is used (e.g., a number of hours during which the component had fluid flowing through the pipe). The period of time is useful in calculation degradation of the component. For example, an iron pipe segment may be known to degrade at a certain rate. By knowing the period of time that the pipe segment is in use, the failure determination module 414 can determine the failure risk level. The failure risk level may be, for example, a low/medium/high classification, a rating from 1 to 5 with 1 being highly unlikely that a component failure will occur and with 5 being highly likely that a component failure will occur.

In examples, when the failure risk level exceeds a first threshold, the component is removed from the well operation. In aspects of the present disclosure, when the failure risk level exceeds a second threshold, the well operation is halted. The first threshold may be a lower threshold than the second threshold in examples of the present disclosure. This enables the well operation to continue until the component is replaced even if the failure risk level exceeds the first threshold but prevents a catastrophic failure by halting well operations when the second threshold is exceeded (or met in some examples). In examples, the first threshold may indicate that the component should be serviced rather than removed from the well operation. In an example using the low/medium/high classification, the first threshold may be a medium classification and the second threshold may be a high classification such that once a medium classification is reached, the component is removed or serviced and once a high classification is reached, the well operation is halted.

In additional examples, the processing system 400 may include additional modules. For example, the processing system 400 may include a reporting module to report the failure risk level for the component by transmitting the identifier associated with the component and the failure risk level to a user device.

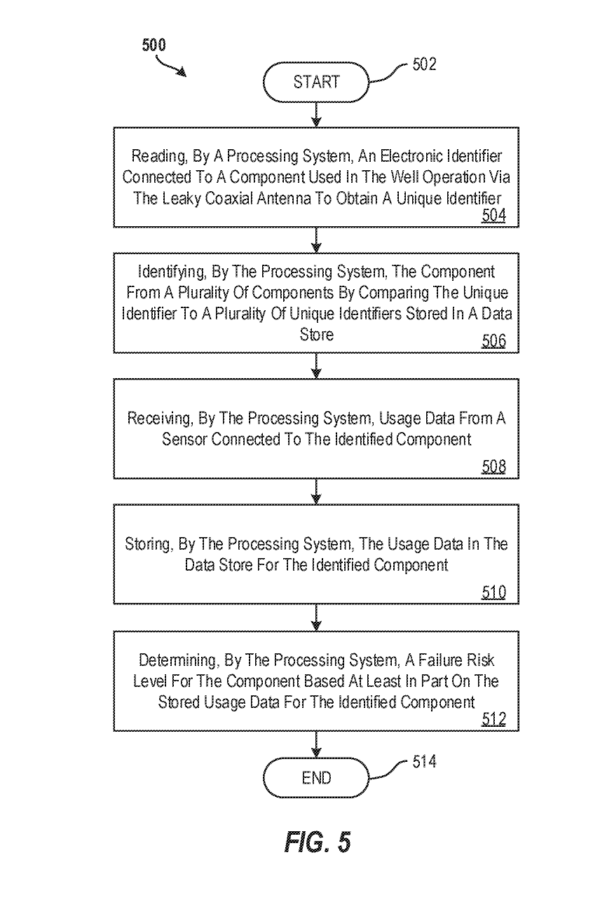

FIG. 5 illustrates a flow diagram of a method 500 for identifying a component used in a well operation using a leaky coaxial antenna according to examples of the present disclosure. The method 500 may be performed by a processing system, such as the component identification system 160 of FIG. 1, the component identification system 260 of FIG. 2, the component identification system 360 of FIG. 3, the processing system 400 of FIG. 4, the processing system 20 of FIG. 6, and/or by another suitable processing system. In describing the method 500, the modules of the processing system 400 of FIG. 4 are referenced; however, such reference is not intended to be limiting. The method 500 starts at block 502 and continues to block 504.

At block 504 of the method 500, the processing system 400 reads an electronic identifier connected to a component used in the well operation via the leaky coaxial antenna to obtain a unique identifier. The electronic identifier includes the unique identifier (e.g., a unique identifier of a RFID tag). The leaky coaxial antenna includes a plurality of radiating regions and a plurality of non-radiating regions. The electronic identifier comprises the unique identifier. At block 506 of the method 500, the processing system 400 identifies the component from a plurality of components by comparing the unique identifier to a plurality of unique identifiers stored in a data store. At block 508 of the method 500, the processing system 400 receives usage data from a sensor connected to the identified component. At block 510 of the method 500, the processing system 400 stores the usage data in the data store for the identified component. At block 512 of the method 500, the processing system 400 determines a failure risk level for the component based at least in part on the stored usage data for the identified component.

The method 500 continues to block 514 and ends. However, additional processes also may be included. For example, the method 500 may further include assigning the unique identifier to the component prior to reading the electronic identifier, and storing the assigned unique identifier in the data store. In some examples, the sensor is a sensor array that includes a density sensor and a flow sensor. In such examples, the method 500 may further include measuring, by the density sensor in fluid communication with the component used in the well operation, a volume of sand flowing through the component over a period of time, and measuring, by the flow sensor in fluid communication with the component used in the well operation, a volume of fluid flowing through the component over the period of time.

The method 500 may further include storing the volume of sand flowing through the component over the period of time in a database, and storing the volume of fluid flowing through the component over the period of time in the database. In such cases, determining the failure risk level is based at least in part on the volume of sand passing through the component over the period of time and based at least in part on the volume of fluid passing through the component over the period of time. The method 500 may further include accessing the database to retrieve the stored volume of sand flowing through the component over the period of time and the stored volume of fluid flowing through the component over the period of time.

Further, the method 500 may include reporting, by the processing system, the failure risk level for the component by transmitting the identifier associated with the component and the failure risk level to a user device. The method 500 may also include removing the component from the well operation when the failure risk level exceeds a first threshold. When the failure risk level exceeds a second threshold, the well operation may be halted.

In examples, the leaky coaxial cable may be installed in a variety of ways. For example, the leaky coaxial cable may be installed at the well operation in proximity to the component such that the electronic identifier is readable by the processing system via a signal transmitted via the leaky coaxial cable. The leaky coaxial cable may also be installed on a vehicle in proximity to the component such that the electronic identifier is readable by the processing system via a signal transmitted via the leaky coaxial cable, wherein the component is stored on the vehicle In aspects of the present disclosure, the leaky coaxial cable is installed in a wellbore at the well operation in proximity to the component such that the electronic identifier is readable by the processing system via a signal transmitted via the leaky coaxial cable

It should be understood that the processes depicted in FIG. 5 represent illustrations, and that other processes may be added or existing processes may be removed, modified, or rearranged without departing from the scope and spirit of the present disclosure.

It is understood in advance that the present disclosure is capable of being implemented in conjunction with any other type of computing environment now known or later developed. For example, FIG. 6 illustrates a block diagram of a processing system 20 for implementing the techniques described herein. In examples, processing system 20 has one or more central processing units (processors) 21a, 21b, 21c, etc. (collectively or generically referred to as processor(s) 21 and/or as processing device(s)). In aspects of the present disclosure, each processor 21 may include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and may include a basic input/output system (BIOS), which controls certain basic functions of processing system 20.

Further illustrated are an input/output (I/O) adapter 27 and a communications adapter 26 coupled to system bus 33. I/O adapter 27 may be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 20 may be stored in mass storage 34. A network adapter 26 interconnects system bus 33 with an outside network 36 enabling processing system 20 to communicate with other such systems.

A display (e.g., a display monitor) 35 is connected to system bus 33 by display adaptor 32, which may include a graphics adapter to improve the performance of graphics intensive applications and a video controller. In one aspect of the present disclosure, adapters 26, 27, and/or 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 may be interconnected to system bus 33 via user interface adapter 28, which may include, for example, a Super I/O chip integrating multiple device adapters into a single integrated circuit.

In some aspects of the present disclosure, processing system 20 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing, and has a highly parallel structure that makes it more effective than general-purpose CPUs for algorithms where processing of large blocks of data is done in parallel.

Thus, as configured herein, processing system 20 includes processing capability in the form of processors 21, storage capability including system memory (e.g., RAM 24), and mass storage 34, input means such as keyboard 29 and mouse 30, and output capability including speaker 31 and display 35. In some aspects of the present disclosure, a portion of system memory (e.g., RAM 24) and mass storage 34 collectively store an operating system such as the AIX® operating system from IBM Corporation to coordinate the functions of the various components shown in processing system 20.

The present techniques may be implemented as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to aspects of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Set forth below are some embodiments of the foregoing disclosure:

### Embodiment 1

A method for identifying a component used in a well operation using a leaky coaxial antenna, the method comprising: reading, by a processing system, an electronic identifier connected to a component used in the well operation via the leaky coaxial antenna to obtain a unique identifier, wherein the electronic identifier comprises the unique identifier; identifying, by the processing system, the component from a plurality of components by comparing the unique identifier to a plurality of unique identifiers stored in a data store; receiving, by the processing system, usage data from a sensor connected to the identified component; storing, by the processing system, the usage data in the data store for the identified component; and determining, by the processing system, a failure risk level for the component based at least in part on the stored usage data for the identified component, wherein the leaky coaxial antenna comprises a plurality of radiating regions and a plurality of non-radiating regions.

### Embodiment 2

The method of any prior embodiment, wherein the electronic identifier is a radio frequency identification (RFID) tag, and wherein reading the electronic identifier comprises reading the RFID tag to receive the unique identifier of the component.

### Embodiment 3

The method of any prior embodiment, wherein the identifier is a microcontroller comprising a wireless input/output connection in communication with the processing system via the leaky coaxial antenna, and wherein reading the electronic identifier comprises the microprocessor sending the unique identifier to the processing system.

### Embodiment 4

The method of any prior embodiment, further comprising: assigning the unique identifier to the component prior to reading the electronic identifier; and storing the assigned unique identifier in the data store.

### Embodiment 5

The method of any prior embodiment, wherein the sensor is a sensor array comprising a density sensor and a flow sensor, the method further comprising: measuring, by the density sensor in fluid communication with the component used in the well operation, a volume of sand flowing through the component over a period of time; and measuring, by the flow sensor in fluid communication with the component used in the well operation, a volume of fluid flowing through the component over the period of time.

### Embodiment 6

The method of any prior embodiment, further comprising: storing the volume of sand flowing through the component over the period of time in a database; and storing the volume of fluid flowing through the component over the period of time in the database, wherein determining the failure risk level is based at least in part on the volume of sand passing through the component over the period of time and based at least in part on the volume of fluid passing through the component over the period of time.

### Embodiment 7

The method of any prior embodiment, further comprising: accessing the database to retrieve the stored volume of sand flowing through the component over the period of time and the stored volume of fluid flowing through the component over the period of time.

### Embodiment 8

The method of any prior embodiment, further comprising: reporting, by the processing system, the failure risk level for the component by transmitting the identifier associated with the component and the failure risk level to a user device.

### Embodiment 9

The method of any prior embodiment, further comprising: removing the component from the well operation when the failure risk level exceeds a first threshold.

### Embodiment 10

The method of any prior embodiment, further comprising: halting the well operation when the failure risk level exceeds a second threshold.

### Embodiment 11

The method of any prior embodiment, wherein the leaky coaxial cable is installed at the well operation in proximity to the component such that the electronic identifier is readable by the processing system via a signal transmitted via the leaky coaxial cable.

### Embodiment 12

The method of any prior embodiment, wherein the leaky coaxial cable is installed on a vehicle in proximity to the component such that the electronic identifier is readable by the processing system via a signal transmitted via the leaky coaxial cable, wherein the component is stored on the vehicle.

### Embodiment 13

The method of any prior embodiment, wherein the leaky coaxial cable is installed in a wellbore at the well operation in proximity to the component such that the electronic identifier is readable by the processing system via a signal transmitted via the leaky coaxial cable.

### Embodiment 14

A system for identifying and determining wear of a component used in a well operation, the system comprising: a memory having computer readable instructions; and a processing device for executing the computer readable instructions, the computer readable instructions comprising: reading, by a processing system, an electronic identifier connected to a component used in the well operation via the leaky coaxial antenna to obtain a unique identifier, wherein the electronic identifier comprises the unique identifier; identifying, by the processing system, the component from a plurality of components by comparing the unique identifier to a plurality of unique identifiers stored in a data store; measuring, by a density sensor in fluid communication with the component used in the well operation, a volume of sand flowing through the component over a period of time; measuring, by a flow sensor in fluid communication with the component used in the well operation, a volume of fluid flowing through the component over the period of time; storing, by the processing system, the volume of sand and volume of water flowing through the component over the period of time as usage data in the data store for the identified component; and determining, by the processing system, a failure risk level for the component based at least in part on the stored usage data for the identified component, wherein the leaky coaxial antenna comprises a plurality of radiating regions and a plurality of non-radiating regions.

### Embodiment 15

The system of any prior embodiment, the computer readable instructions further comprising: halting the well operation when the failure risk level exceeds a threshold.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

Additionally, the term “about” is intended to include the degree of error associated with measurement of the particular quantity based upon the equipment available at the time of filing the application. For example, “about” can include a range of ±8% or 5%, or 2% of a given value.

While one or more embodiments have been shown and described, modifications and substitutions may be made thereto without departing from the spirit and scope of the invention. Accordingly, it is to be understood that the present invention has been described by way of illustrations and not limitation.

What is claimed is:

1. A method for identifying a component used in a well operation using a leaky coaxial antenna, the method comprising:
reading, by a processing system, an electronic identifier connected to a component used in the well operation via the leaky coaxial antenna to obtain a unique identifier, wherein the electronic identifier comprises the unique identifier;
identifying, by the processing system, the component from a plurality of components by comparing the unique identifier to a plurality of unique identifiers stored in a data store;
receiving, by the processing system, usage data from a sensor connected to the identified component;
storing, by the processing system, the usage data in the data store for the identified component; and
determining, by the processing system, a failure risk level for the component based at least in part on the stored usage data for the identified component,
wherein the leaky coaxial antenna comprises a plurality of radiating regions and a plurality of non-radiating regions.

2. The method of claim 1, wherein the electronic identifier is a radio frequency identification (RFID) tag, and wherein reading the electronic identifier comprises reading the RFID tag to receive the unique identifier of the component.

3. The method of claim 1, wherein the identifier is a microcontroller comprising a wireless input/output connection in communication with the processing system via the leaky coaxial antenna, and wherein reading the electronic identifier comprises the microprocessor sending the unique identifier to the processing system.

4. The method of claim 1, further comprising:
assigning the unique identifier to the component prior to reading the electronic identifier; and
storing the assigned unique identifier in the data store.

5. The method of claim 1, wherein the sensor is a sensor array comprising a density sensor and a flow sensor, the method further comprising:
measuring, by the density sensor in fluid communication with the component used in the well operation, a volume of sand flowing through the component over a period of time; and
measuring, by the flow sensor in fluid communication with the component used in the well operation, a volume of fluid flowing through the component over the period of time.

6. The method of claim 5, further comprising:
storing the volume of sand flowing through the component over the period of time in a database; and
storing the volume of fluid flowing through the component over the period of time in the database,
wherein determining the failure risk level is based at least in part on the volume of sand passing through the component over the period of time and based at least in part on the volume of fluid passing through the component over the period of time.

7. The method of claim 6, further comprising:
accessing the database to retrieve the stored volume of sand flowing through the component over the period of time and the stored volume of fluid flowing through the component over the period of time.

8. The method of claim 1, further comprising:
reporting, by the processing system, the failure risk level for the component by transmitting the identifier associated with the component and the failure risk level to a user device.

9. The method of claim 1, further comprising:
removing the component from the well operation when the failure risk level exceeds a first threshold.

10. The method of claim 1, further comprising:
halting the well operation when the failure risk level exceeds a second threshold.

11. The method of claim 1, wherein the leaky coaxial cable is installed at the well operation in proximity to the component such that the electronic identifier is readable by the processing system via a signal transmitted via the leaky coaxial cable.

12. The method of claim 1, wherein the leaky coaxial cable is installed on a vehicle in proximity to the component such that the electronic identifier is readable by the processing system via a signal transmitted via the leaky coaxial cable, wherein the component is stored on the vehicle.

13. The method of claim 1, wherein the leaky coaxial cable is installed in a wellbore at the well operation in proximity to the component such that the electronic identifier is readable by the processing system via a signal transmitted via the leaky coaxial cable.

14. A system for identifying and determining wear of a component used in a well operation, the system comprising:
a memory having computer readable instructions; and
a processing device for executing the computer readable instructions, the computer readable instructions comprising:
reading, by a processing system, an electronic identifier connected to a component used in the well operation via the leaky coaxial antenna to obtain a unique identifier, wherein the electronic identifier comprises the unique identifier;
identifying, by the processing system, the component from a plurality of components by comparing the unique identifier to a plurality of unique identifiers stored in a data store;
measuring, by a density sensor in fluid communication with the component used in the well operation, a volume of sand flowing through the component over a period of time;
measuring, by a flow sensor in fluid communication with the component used in the well operation, a volume of fluid flowing through the component over the period of time;
storing, by the processing system, the volume of sand and volume of water flowing through the component over the period of time as usage data in the data store for the identified component; and
determining, by the processing system, a failure risk level for the component based at least in part on the stored usage data for the identified component,
wherein the leaky coaxial antenna comprises a plurality of radiating regions and a plurality of non-radiating regions.

15. The system of claim 1, the computer readable instructions further comprising:
halting the well operation when the failure risk level exceeds a threshold.
